(19) United States
(12) Patent Application Publication
(10) Pub. No.: US 2005/0289009 A1
(43) Pub. Date: Dec. 29, 2005

(54) Electronic data storage and retrieval system for the real estate industry

(75) Inventors: Michael Martirena, Miami Beach, FL (US); Jason Clark Bodine, Miami, FL (US)

Correspondence Address: Michael Martirena, Apt. 413, 1401 Bay Road, Miami Beach, FL, 33139, US

(73) Assignee: Michael Martirena

(21) Appl. No.: 11/145,363

(22) Filed: Jun. 6, 2005

Related U.S. Application Data
(60) Provisional application No. 60/582,528, filed on Jun. 25, 2004.

(51) Int. Cl. G06Q 20/00

(52) U.S. Cl. 705/23

(57) ABSTRACT

An Electronic Data Storage and Retrieval System For the Real Estate Industry includes: Device consists of electronic chip that is placed in Realty Signage. Realtor/ Purchaser/Seller have the ability to scan the chip or access through wireless technology and are provided with the most up to date information listed on realty listing services. Scanning device will consist of handheld system with electronic capability to read program from chip in signage. Computer may be used with compatible software.

### CROSS-REFERENCE TO REALTED APPLICATIONS

This non-provisional application claims benefit of U.S. Patent Provisional Application Ser. No. 60/5825286252004, entitled “Electronic Data Storage and Retrieval System For the Real Estate Industry”, filed on Jun. 22, 2004.

### FILED OF INVENTION

The present invention related to a data storage and retrieval system and more particularly to a system for storage and retrieval of data for use in the real estate industry.

### BACKGROUND OF THE INVENTION

Current buyers and sellers of commercial and residential real estate have various ways to obtain information regarding the specifications of certain properties. These include accessing realtors' web sites, reviewing written information left on the property, requesting the realtor to show properties and explain realty listing service information. All of these methods are time consuming to the buyer and often times contain outdated information. The buyer cannot get instantaneous information while viewing a property.

The present device provides a new and improved method to store and update data and allow buyers and sellers to retrieve that data for instantaneous current information relating to the real estate in question. The device can be modified for use with a variety of current real estate agent information systems. Buyers and sellers of commercial and residential real estate will have the ability to access current realty listing service information which is stored on a computer chip placed on the Realty signage. The chip can be updated as needed for the most current information. The realtor or potential buyer will have the ability to scan or receive a signal to a handheld device for wireless transformation of information which gives all the specifications listed on the current realty listing service, for example price, square footage, taxes, utilities and any other pertinent information that the seller needs to relate to the buyer in order for the buyer to make an informed purchase decision. This allows the buyer to “shop” properties individually without the need of an agent. An alternative way to retrieve the information is through use of a computer with unique software program installed which can read the information stored on the chip.

### SUMMARY OF THE INVENTION

A summary of the invention, an Electronic Data Storage and Retrieval System for the Real Estate Industry, is provided including: Device consists of electronic chip that is placed in realty signage placed at the property location. Realtor/Purchaser has the ability to scan the chip and are then provided with the most up to date information displayed on the realty listing services. Device that is used to scan the chip will consist of handheld system with electronic capability to read program from chip in signage. An alternative way to retrieve the information is through use a computer with a unique software program.

### BRIEF DESCRIPTION OF THE DRAWING

Not Applicable

### DETAILED DESCRIPTION OF THE INVENTION

A descriptive embodiment of the invention, an Electronic Data Storage and Retrieval System For the Real Estate Industry, is provided including: Device consists of electronic chip that is placed in realty signage. Realtor, seller or buyer of property have the ability to scan the chip and retrieve the most up to date information listed on the realty listing service. Scanning device will consist of handheld system with electronic capability to read program from chip in signage. An alternative way to retrieve the information is through the use of a computer with unique software installed.

The electronic storage and retrieval system is to utilize existing RFID technology or similar in the real estate market. The system is designed to allow “on the fly” information retrieval by real estate agents and interested parties in the real estate market. Information is to be pulled from online sources, such as the realty listing service, by listing number or other unique indicator, and programmed into external storage device.

The external storage device (Chip, ect) is to be attached to existing positioned, real estate signs to allow enabled users to get greater, more complete listing information immediately, directly, and instantaneously from remote location.

Information is to be viewed on existing handheld system machinery such as hand held devices (like PDA's), or laptop devices, once software is enabled.

Features:

Data storage device, ex smart chip, magnetic strip, bar code;

Data retrieval device, ex: attachment to, or hand held scanning device or laptop computer.

Software Characteristics:

Transfer information from external source to storage device;

Decode information from external device;

Enable retrieval device to read decoded information.

1. A device for electronic storage and retrieval system for information regarding commercial and residential properties comprising:
a. The external storage device (chip) is to be attached to existing positioned real estate signs;
b. A hand held scanning device will be used to scan a bar code, magnetic strip or receive a wireless signal to download information from chip;
c. A laptop equipped with unique software may be used to receive wireless information from chip.

2. The chip of claim 1 to have decoding capability through software to read information downloaded from external informational sources.

3. The handheld scanning device from claim 1 to incorporate technology for scanning a bar code, or magnetic strip, or receive a wireless signal from the chip of claim 1.

4. The computer software from claim 1 to be unique in order to read the decoded information stored in the chip.
